(19) United States
(12) Patent Application Publication
(10) Pub. No.: US 2007/0118365 A1
(43) Pub. Date: May 24, 2007

(54) Methods and apparatuses for variable dimension vector quantization

(76) Inventor: Wai C. Chu, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/654,122

(22) Filed: Jan. 16, 2007

Related U.S. Application Data
(62) Division of application No. 10/379,201, filed on Mar. 4, 2003.

(51) Int. Cl. G10L 19/00

(52) U.S. Cl. 704/219

(57) ABSTRACT

Improved variable dimension vector quantization-related (“VDVQ-related”) processes have been developed that provide quality improvements over known coding processes in codebook optimization and the quantization of harmonic magnitudes that can be applied to a broad range of distortion measures, including those that would involve inverting a singular matrix using known centroid computation techniques. The improved VDVQ-related processes improve the way in which actual codevectors are extracted from the codevectors of the codebook by redefining the index relationship and using interpolation to determine the actual codevector elements when the index relationship produces a non-integer value. Additionally, these processes improve the way in which codebooks are optimized using the principles of gradient-descent. These improved VDVQ-related processes can be implemented in various software and hardware implementations.

This is a divisional of application Ser. No. 10/379,201, filed on Mar. 4, 2003, entitled “Methods and Apparatuses for Variable Dimension Vector Quantization,” and assigned to the corporate assignee of the present invention and incorporated herein by reference.

### BACKGROUND

Speech analysis involves obtaining characteristics of a speech signal for use in speech-enabled and/or related applications, such as speech synthesis, speech recognition, speaker verification and identification, and enhancement of speech signal quality. Speech analysis is particularly important to speech coding systems.

Speech coding refers to the techniques and methodologies for efficient digital representation of speech and is generally divided into two types, waveform coding systems and model-based coding systems. Waveform coding systems are concerned with preserving the waveform of the original speech signal. One example of a waveform coding system is the direct sampling system which directly samples a sound at high bit rates (“direct sampling systems”). Direct sampling systems are typically preferred when quality reproduction is especially important. However, direct sampling systems require a large bandwidth and memory capacity. A more efficient example of waveform coding is pulse code modulation.

In contrast, model-based speech coding systems are concerned with analyzing and representing the speech signal as the output of a model for speech production. This model is generally parametric and includes parameters that preserve the perceptual qualities and not necessarily the waveform of the speech signal. Known model-based speech coding systems use a mathematical model of the human speech production mechanism referred to as the source-filter model.

The source-filter model models a speech signal as the air flow generated from the lungs (an “excitation signal”), filtered with the resonances in the cavities of the vocal tract, such as the glottis, mouth, tongue, nasal cavities and lips (a “synthesis filter”). The excitation signal acts as an input signal to the filter similarly to the way the lungs produce air flow to the vocal tract. Model-based speech coding systems using the source-filter model generally determine and code the parameters of the source-filter model. These model parameters generally include the parameters of the filter. The model parameters are determined for successive short time intervals or frames (e.g., 10 to 30 ms analysis frames), during which the model parameters are assumed to remain fixed or unchanged. However, it is also assumed that the parameters will change with each successive time interval to produce varying sounds.

The parameters of the model are generally determined through analysis of the original speech signal. Because the synthesis filter generally includes a polynomial equation including several coefficients to represent the various shapes of the vocal tract, determining the parameters of the filter generally includes determining the coefficients of the polynomial equation (the “filter coefficients”). Once the filter coefficients for the synthesis filter have been obtained, the excitation signal can be determined by filtering the original speech signal with a second filter that is the inverse of the synthesis filter (an “analysis filter”).

Methods for determining the filter coefficients include linear prediction analysis (“LPA”) techniques or processes. LPA is a time-domain technique based on the concept that during a successive short time interval or frame “N,” each sample of a speech signal (“speech signal sample” or “s[n]”) is predictable through a linear combination of samples from the past s[n−k] together with the excitation signal u[n]. The speech signal sample s[n] can be expressed by the following equation:

$$s [ n ] = {\sum }_{k = 1}^{M} {a}_{k} s [ n - k ] + Gu [ n ] \qquad ( 1 )$$

where G is a gain term representing the loudness over a frame with a duration of about 10 ms, M is the order of the polynomial (the “prediction order”), and aₖ are the filter coefficients which are also referred to as the “LP coefficients.” The filter is therefore a function of the past speech samples s[n] and is represented in the z-domain by the formula:
H[z]=G/A[z] (2)
A[z] is an M order polynomial given by:

$$A [ z ] = 1 + {\sum }_{k = 1}^{M} {a}_{k} {z}^{- k} \qquad ( 3 )$$

The order of the polynomial A[z] can vary depending on the particular application, but a 10th order polynomial is commonly used with an 8 kHz sampling rate.

The LP coefficients aₗ. . . a_{M} are computed by analyzing the actual speech signal s[n]. The LP coefficients are approximated as the coefficients of a filter used to reproduce s[n] (the “synthesis filter”). The synthesis filter uses the same LP coefficients as the analysis filter and when driven by an excitation signal, produces a synthesized version of the speech signal. The synthesized version of the speech signal may be estimated by a predicted value of the speech signal s[n]. s[n] is defined according to the formula:

$$\tilde{s} [ n ] = - {\sum }_{k = 1}^{M} {a}_{k} s [ n - k ] \qquad ( 4 )$$

Because s[n] and s[n] are not exactly the same, there will be an error associated with the predicted speech signal s[n] for each sample n referred to as the prediction error eₚ[n], which is defined by the equation:

$${e}_{p} [ n ] = s [ n ] - \tilde{s} [ n ] = s [ n ] + {\sum }_{k = 1}^{M} {a}_{k} s [ n - k ] \qquad ( 5 )$$

Interestingly enough, the prediction error eₚ[n] is also equal to the excitation signal scaled by the gain. Where the sum of all the prediction errors defines the total prediction error Eₚ:
Eₚ=Σeₚ²[k] (6)
where the sum is taken over the entire speech signal. The LP coefficients aₗ. . . a_{M} are generally determined so that the total prediction error Eₚ is minimized (the “optimum LP coefficients”).

One common method for determining the optimum LP coefficients is the autocorrelation method. The basic procedure consists of signal windowing, autocorrelation calculation, and solving the normal equation leading to the optimum LP coefficients. Windowing consists of breaking down the speech signal into frames or intervals that are sufficiently small so that it is reasonable to assume that the optimum LP coefficients will remain constant throughout each frame. During analysis, the optimum LP coefficients are determined for each frame. These frames are known as the analysis intervals or analysis frames. The LP coefficients obtained through analysis are then used for synthesis or prediction inside frames known as synthesis intervals. However, in practice, the analysis and synthesis intervals might not be the same.

When windowing is used, assuming for simplicity a rectangular window of unity height including window samples w[n], the total prediction error Ep in a given frame or interval may be expressed as:

$${E}_{p} = {\sum }_{k = n 1}^{n 2} {e}_{p}^{2} [ k ] \qquad ( 7 )$$

where n1 and n2 are the indexes corresponding to the beginning and ending samples of the window and define the synthesis frame.

Once the speech signal samples s[n] are isolated into frames, the optimum LP coefficients can be found through autocorrelation calculation and solving the normal equation. To minimize the total prediction error, the values chosen for the LP coefficients must cause the derivative of the total prediction error with respect to each LP coefficients to equal or approach zero. Therefore, the partial derivative of the total prediction error is taken with respect to each of the LP coefficients, producing a set of M equations. Fortunately, these equations can be used to relate the minimum total prediction error to an autocorrelation function:

$${E}_{p} = {R}_{p} [ 0 ] - {\sum }_{i = 1}^{M} {a}_{i} {R}_{p [} k ] \qquad ( 8 )$$

where M is the prediction order and Rₚ(k) is an autocorrelation function for a given time-lag l which is expressed by:

$$R [ l ] = {\sum }_{k = l}^{N - 1} w [ k ] s [ k ] w [ k - l ] s [ k - l ] \qquad ( 9 )$$

where s[k] is a speech signal sample, w[k] is a window sample (collectively the window samples form a window of length N expressing in number of samples) and s[k−l] and w[k−l] are the input signal samples and the window samples lagged by l. It is assumed that w[n] may be greater than zero only from k=0 to N−1. Because the minimum total prediction error can be expressed as an equation in the form Ra=b (assuming that Rₚ[0] is separately calculated), the Levinson-Durbin algorithm may be used to solve the normal equation in order to determine for the optimum LP coefficients.

Unfortunately, no matter how well the model parameters are represented, the quality of the synthesized speech produced by speech coders will suffer if the excitation signal u[n] is not adequately modeled. In general, the excitation signal is modeled differently for voiced segments and unvoiced segments. While the unvoiced segments are generally modeled by a random signal, such as white noise, the voiced segments generally require a more sophisticated model. One known model used to model the voiced segments of the excitation signal is the harmonic model.

The harmonic model models periodic and quasi-periodic signals, such as the voiced segments of the excitation signal u[n] as the sum of more than one sine wave according to the following equation:

$$u [ n ] = {\sum }_{j = 1}^{N ( T )} {x}_{j} cos ( {ω}_{j} n + {θ}_{j} ) \qquad ( 10 )$$

where each sine wave xⱼcos(ωⱼn+θⱼ) is known as a harmonic component, and each harmonic component has a frequency value that is an integer multiple “j” of a fundamental frequency ωₒ; ωⱼ is the frequency of the j-th harmonic component (the “harmonic frequency”); xⱼ is the magnitude of the j-th harmonic component (the “harmonic magnitude”); θⱼ is the phase of the j-th harmonic component (the “harmonic phase”); and N(T) is the number of harmonic components. The harmonic frequency ωⱼ is defined according to the following equation:

$${ω}_{j} = \frac{2 π j}{T} ; j = 1 , 2 , … , N ( T ) \qquad ( 11 )$$

where T is the pitch period representing the periodic nature of the signal and is related to the fundamental frequency according to the following equation:

$$T = \frac{2 π}{{ω}_{o}} \qquad ( 12 )$$

Together, all the harmonic magnitude components xⱼ, j=1, 2,. . . , N(T) form a vector (a “harmonic magnitude vector” or “harmonic magnitude”) according to the following equation:
x^{T}=[x₁ x₂ xⱼ . . . x_{N(T)}] (13)
where the number of harmonic components (also referred to as the “harmonic magnitude vector dimension”) N(T) is defined according to the following equation:

$$N ( T ) = \frac{α T}{2} \qquad ( 14 )$$

where α is a constant (the “period constant”) and is often selected to be slightly lower than one so that the harmonic component at the frequency ω=π is excluded. As indicated in equation (14), the number of harmonic components N(T) is a function of the pitch period T. The typical range of values for T in speech coding applications is [20,147] and is generally encoded with 7 bits. Under these circumstances and with α=0.95, N(T)ε[9,69].

Together, the fundamental frequency or pitch period, harmonic magnitudes and harmonic phases comprise the three harmonic parameters used to represent the voiced excitation signal. The harmonic parameters are determined once per analysis frame using a group of techniques, where each techniques is referred to as “harmonic analysis.” In the harmonic model, if the analysis frame is short enough so that it can be assumed that the pitch or pitch period does not change within the frame, it can also be assumed that the harmonic parameters do not change over the analysis frame. Additionally, in speech coding applications, it can be assumed that only the phase continuity and not the harmonic phases of the harmonic components are needed to create perceptually accurate synthetic speech signals. Therefore, for speech coding applications, harmonic analysis generally refers only to the procedures used to extract the fundamental frequency and the harmonic magnitudes.

An example of a known harmonic analysis process used to extract the harmonic parameters of the excitation signal of a speech signal is shown in FIG. 1. The harmonic analysis process 200 is performed on a frame-by-frame basis for each frame of the excitation signal u[n] and generally includes: windowing and converting the excitation signal into the frequency domain 206; and performing spectral analysis 207. Windowing and converting the excitation signal into the frequency domain 206 includes windowing a frame of the excitation signal to produce a windowed excitation signal and transforming the windowed excitation signal into the frequency domain using the fast Fourier transform (“FFT”). The window used to window the excitation signal frame may be a Hamming or other type of window. If the window is longer than the frame, the frame is padded with samples having zero magnitude.

Performing spectral analysis 207 basically includes, estimating the pitch period 208; locating the magnitude peaks 210; and extracting the harmonic magnitudes from the magnitude peaks 212. Estimating the pitch period 208 includes determining the pitch period T or the fundamental frequency ωₒ using known pitch extraction techniques. The pitch period may be estimated from either the excitation signal or the original speech signal. Locating the magnitude peaks 210 is accomplished using the pitch period and gives the location of the harmonic components. The harmonic magnitudes are then extracted from the magnitude peaks in step 212.

There are many known speech coders that use the harmonic model as the basis for modeling the voiced segments of the excitation signal (the “voiced excitation signal”). These coders represent the harmonic parameters with varying levels of complexity and accuracy and include coders that use the following techniques: constant magnitude approximations such as that used by some linear prediction (“LPC”) coders; partial harmonic magnitude techniques such as that used by mixed excitation linear prediction-type (“MELP-type”)of coders; vector quantization techniques including, variable to fixed dimension conversion techniques such as that used by harmonic vector excitation coders (“HVXC”); and variable dimension vector quantization techniques.

In order to compare the performance of these coders, spectral distortion (“SD”) is often used as a performance indicator for both models and, as will be discussed later, quantizers. SD provides a measure of the distortion caused by representing a value f(xⱼ) (through modeling and/or quantizing) with another value f(yⱼ), and is determined according to the following equation:

$$SD = \sqrt{\frac{1}{N ( T )} {\sum }_{j = 1}^{N ( T )} {( f ( {x}_{j} ) - f ( {y}_{j} ) )}^{2}} . \qquad ( 15 )$$

where, xⱼ and yⱼ each represent a set of harmonic magnitudes, and f(•)=20log₁₀(•) converts the harmonic magnitudes to the decibel domain (dB).

Constant magnitude approximations use a very crude approximation of the harmonic magnitudes to model the excitation signal (referred to herein as the “constant magnitude approximation”). In the constant magnitude approximation, used by some standard LPC coders (for example, see T. Tremain, “The Government Standard Linear Predictive Coding Algorithm: LPC-10,”Speech Technology Magazine, pp. 40-49, April 1982), the voiced excitation signal is represented by a series of periodic uniform-amplitude pulses. These pulses have a harmonic structure in the frequency domain which roughly approximates the harmonic magnitudes xⱼ of the voiced excitation signal. The constant magnitude approach thus represents the voiced excitation signal by a constant value “a” for each of its harmonic magnitudes xⱼ, where the modeled or approximated harmonic magnitudes (each “yⱼ”) are generally expressed in the log domain f(yⱼ)=20log(yⱼ), according to the following equation:
f(yⱼ)=a; j=1, 2, . . . , N(T) (16)

To minimize the SD, “a” is determined as the arithmetic mean of the harmonic magnitudes in the log domain, according to the equation:

$$a = \frac{1}{N ( T )} {\sum }_{j = 1}^{N ( T )} f ( {x}_{j} ) \qquad ( 17 )$$

where each f(xⱼ)=20log(xⱼ), and N(T) is the number of harmonic magnitudes. Although LPC coders using the constant magnitude approximation can produce intelligible synthesized speech at low bit rates, the quality is generally considered poor.

Quality improvements can be achieved by modeling only some of the harmonic components with a constant value. In a partial harmonic magnitude technique, a specified number of harmonic magnitudes are preserved while the rest are modeled by a constant value. The rationale behind this technique is that the perceptually important components of the excitation signal are often located in the low frequency region. Therefore, even by preserving only the first few harmonic magnitudes, improvements over LPC coders can be achieved.

In one example, where the partial harmonic magnitude technique is implemented in the federal standard version of an MELP-type coder (see A. W. McCree et al, “MELP: the New Federal Standard at 2400 BPS,” IEEE ICASSP, pp. 1591-1594, 1997), the first ten (10) modeled harmonic magnitudes in the log domain f(yⱼ) are made equal to the actual harmonic magnitudes in the log domain f(xⱼ), but the remaining N(T)-10 harmonic magnitudes are set equal to a constant value “a” according to the following equations:
f(yⱼ)=f(xⱼ); j=1, 2, . . . , 10 (18)
f(yⱼ)=a; j=11, . . ., N(T) (19)

$$a = \frac{1}{N ( T ) - 10} {\sum }_{j = 11}^{N ( T )} f ( {x}_{j} ) \qquad ( 20 )$$

assuming N(T)>10. If equations (18), (19) and (20) are satisfied, the SD is minimized. However, in practice, equation (18) cannot be satisfied because representing the harmonic magnitude exactly would require an infinite number of bits (infinite resolution) which cannot be stored or transmitted in actual physical systems. The partial harmonic magnitude technique works best for encoding speech signals with a low pitch period, such as those produced by females or children, because a smaller amount of distortion is introduced when the number of harmonics is small. However, when encoding speech signals produced by males, the distortion is higher because this type of speech signal possesses a greater number of harmonics.

Although, in some cases, it is possible for the harmonic model to produce high quality synthesized speech signals, the harmonic parameters, particularly the harmonic magnitudes, can require a great many bits for their representation. The harmonic magnitudes can, however, be represented in a much more efficient manner if their possible values are limited through quantization. Once the possible values are defined and limited, each harmonic magnitude can be rounded-off or “quantized” to the most appropriate of these limited values. A group of techniques for defining a limited set of possible harmonic magnitudes and the rules for mapping harmonic magnitudes to a possible harmonic magnitude in this limited set are collectively referred to as vector quantization techniques.

Vector quantization techniques include the methods for finding the appropriate codevector for a given harmonic magnitude (“quantization”), and generating a codebook (“codebook generation”). In vector quantization, a codebook Y lists a finite number N_{c} of possible harmonic magnitudes. Each of these N_{c} possible harmonic magnitudes yᵢ is referred to as a “codebook entry,” “entry” or “codevector” and are defined according to the following equation:
y₁^{T}=[y_{i,0} y_{i,l} . . . y_{i,Nv-l}] (21)
where each y_{i,j} is one of Nᵥ components of the i-th codevector (each y_{i,j} a “codevector component”); Nᵥ is the codevector dimension; and “i” is a codevector index. Using the codebook to encode the harmonic magnitudes of the excitation signal involves finding the appropriate entry, and determining the codevector index associated with that entry. This enables each harmonic magnitude to be quantized to one of a finite number of values and represented solely by the corresponding codevector index. It is this codevector index that, along with the pitch period and other parameters, represents the harmonic magnitude for storage and/or transmission. Because the codebook is known to both the encoder and the decoder, the codevector index can also be used to recreate the harmonic magnitude.

However, before any harmonic magnitudes can be quantized, the vector quantization technique must generate a codebook, which includes determining the codevectors and the rule or rules for mapping all possible harmonic magnitudes to an appropriate codevector (“partitioning”). Codebook generation generally includes determining a finite set of codevectors in order to reduce the number of bits needed to represent the harmonic magnitudes. Partitioning defines the rules for quantization, which are basically the rules that govern how each potential harmonic magnitude is “quantized” or rounded-off.

There are several known methods for codebook generation (“codebook generation methods”), which, in general, include defining a partition rule and initial values for the codevectors; and using an iterative approach to optimize these codevectors for a given training data set according to some performance measure. The training data set is a finite set of vectors (“input vectors”) that represent all the possible harmonic magnitudes that may require quantization, which is used to create a codebook. A finite training data set is used to create the codebook because determining a codebook based on all possible harmonic magnitudes would be too computationally intensive and time consuming.

One example of a known codebook generation method is the generalized Lloyd algorithm (“GLA”) which is shown in FIG. 2 and indicated by reference number 250. The GLA 250 generally includes, collecting a training data set 252; defining a codebook 254; defining a partition rule 256; partitioning the training data set according to the partition rule and the codebook 258; optimizing the codebook for the partition using centriod computation 260; and determining whether an optimization criterion has been met 262, where if the optimization criterion has not been met, repeating partitioning the training data set according to the partition rule and the codebook 258; optimizing the codebook for the partition using centriod computation 260; and determining whether an optimization criterion has been met 262 until the optimization criterion has been met.

Collecting a training data set 252 includes defining a set of input vectors containing Nₜ vectors as representative of the possible harmonic magnitude vectors, where each input vector xₖ is associated with a pitch period Tₖ for k=O to Nₜ -1, and denoted according to the following equation:
{xₖ, Tₖ} (22)

Defining a codebook 254 generally includes selecting initial values for the codevectors in the codebook by random selection or other known method. Additionally, the steps 252, 254 and 265 can be performed in any order, simultaneously, or any combination of the foregoing.

Defining a partition rule 256 generally includes adopting the nearest-neighbor condition and defining a distortion measure. Under the nearest-neighbor condition, an input vector is mapped to the codevector with which the input vector minimizes some measure of distortion. The distortion measure is generally defined by some measure of distance between an input vector xₖ and a codevector yⱼ (the “distance measure d(yⱼ, xₖ)”). It is this distance measure d(yⱼ, xₖ) that, along with the partition rule, is then used in step 258 to partition the training data set.

Partitioning the training data set 258 includes mapping each input vector in the training data set to a codevector according to the nearest-neighbor condition and the distance measure. This essentially amounts to dividing the training data into cells (creating a “partition”), where each cell includes a codevector and all the input vectors that are mapped to that codevector. The partition is determined so that within each cell the average distance measure, as determined between each input vector in the cell and the codevector in the cell, is minimized, yielding the optimum partition. Determining the optimum partition includes determining to which codevector each input vector should be mapped so that the distance between a given input vector and the codevector to which it is mapped is smaller than the distance between that input vector and any of the other codevectors. In other words, an input vector is said to be mapped to the i-th cell if the following equation is satisfied for all j≠i:
d(yᵢ, xₖ)≦d(yⱼ, xₖ) (23)

Because satisfying the nearest-neighbor condition is generally accomplished using an exhaustive search method, it is sometime known as the “nearest neighbor search.”

Once the optimum partition is known, the codebook is then optimized using centroid computation 260. Optimizing the codebook 260 generally includes, determining the optimum codevectors, which are the codevectors that minimize the sum of the distortions at each cell. Because the distortion measure is generally defined in step 256 as some distance measure d(yⱼ, xₖ), the sum of the distance measures at each cell is expressed according to the following equation:

$${D}_{t} = {\sum }_{k , {i}_{k} = i} d ( {x}_{k} , {y}_{i} ) \qquad ( 24 )$$

where iₖ is the index of the cell to which xₖ pertains. The sum of the distance measure is minimized by the centroid of the cell. In the present context, a centroid is the point in the cell from which the average distance to all the other vectors in the cell is the lowest, which can be determined using a centroid computation. Therefore, the optimum codevectors are the centroids for their respective cells as determined by centroid computation, where the exact manner in which the centroid computation is performed is determined by the distance measure defined in step 256.

Because the GLA 250 produces an approximation of the optimum partition and the optimum codebook, it is determined in step 260 whether the optimum partition and optimum codebook are sufficiently optimized by determining if some optimization criterion has been met. One example of an optimization criterion is reaching the saturation of the total sum of distances for all cells, which is the point at which the total sum of distances for all cells remains constant or decreases by less than a predetermined value. If the criterion has not been met, steps 258, 260 and 261 are repeated until the optimization criterion has been met. When the optimization criterion has been met, the most recent codebook is defined as the optimum codebook.

Once the codebook has been generated, harmonic magnitudes can then be quantized. Quantization in vector quantization is the process by which a harmonic magnitude vector x (with harmonic magnitude elements, each “xₖ”) in k-dimensional Euclidean space (“R^{k}”), is mapped into one of N_{c} codevectors. A harmonic magnitude is mapped to the appropriate codevector according to the partition rule. If the partition rule is the nearest-neighbor condition, the appropriate codevector for a given harmonic magnitude is the codevector that, together with that harmonic magnitude, provides the lowest distortion between that harmonic magnitude and each of the codevectors. Therefore, to quantize a harmonic magnitude, the distortion between the harmonic magnitudes and each codevector in the codebook is determined according to the distance measure, and the harmonic magnitude is then represented by the codevector that, together with that harmonic magnitude, created the smallest distortion.

Although vector quantization reduces the distortion inherent in the MELP-type coders, it introduces its own errors because vector quantization can only be used in cases where the harmonic magnitude dimension N(T) equals the codevector dimension Nᵥ, and harmonic magnitudes generally do not have a fixed dimension. Therefore, if the harmonic magnitude vectors have a variable dimension, another vector quantization technique must be used that can map variable dimension harmonic magnitudes to the fixed-dimension codebook entries. There are several known vector quantization techniques that may be used including: variable to fixed dimension conversion using interpolation (“variable to fixed conversion techniques”) and variable dimension vector quantization techniques (“VDVQ techniques”).

Variable to fixed conversion techniques generally include converting the variable dimension harmonic magnitude vectors to vectors of fixed dimension using a transformation that preserves the general shape of the harmonic magnitude. One example of a variable to fixed dimension conversion technique is the one implemented in the harmonic vector excitation coding (“HVXC”) coder (see M. Nishiguchi, et al. “Parametric Speech Coding- HVXC at 2.0-4.0 KBPS,” IEEE Speech Coding Workshop, pp. 84-86, 1999). The variable to fixed conversion technique used by the HVXC coder relies on a double interpolation process, which includes converting the original dimension of the harmonic magnitude, which is in the range of [9, 69] to a fixed dimension of 44. When a speech signal encoded using this technique is subsequently reproduced, a similar double-interpolation procedure is applied to the encoded 44 dimension harmonic magnitude vectors to convert them back into their original dimensions. On the encoding side, the HVXC coder uses a multi-stage vector quantizer having four bits per stage with a total of 13 bits (including 5 bits used to quantize the gain) to encode the harmonic magnitudes. With the previously described configuration, the HVXC coder is used for 2 kbit/s operation. It can also be used for 4 kbit/s operation by adding enhancements to the encoded harmonic magnitudes.

VDVQ is a vector quantization technique that uses an actual codevector to determine to which fixed dimension codevector a variable dimension harmonic magnitude vector should be mapped. This process is shown in more detail in FIG. 3. The VDVQ procedure 300 includes extracting an actual codevector for each codevector in a codebook 302; computing the distortion between the harmonic magnitude vector and each actual codevector 304; and choosing the codevector corresponding to the optimum actual codevector 306.

An actual codevector uᵢ is a vector that is extracted from a codevector in a codebook but that has the same dimension N(T) (the “variable actual codevector dimension”) as the harmonic magnitude vector being quantized, and is expressed according to the following equation:
uᵢ^{T}=[u_{i,1} u_{i,2} . . . u_{i,N(T)}] (25)

The actual codevectors are related to the codevectors according to the following equation:
uᵢ=C(T)yᵢ (26)
where C(T) is a selection matrix associated with the pitch period T and defined according to the following equation:
C(T)=c^{T}_{j,m}; for all j=1, . . . , N(T) and m=0, . . . , Nᵥ−1 (27)
where each element of the selection matrix (each a “selection matrix element” or “c^{T}_{j,m}”) is defined according to the following equations:
c^{T}_{j,m}=1; if index(T,j)=m (28a)
c^{T}_{j,m}=0; otherwise (28b)

Each actual codevector includes codevector elements, where each actual codevector element u_{i,j} is related to a corresponding codevector element y_{i,j} as a function of a codevector index index(T,j) and according to the following equation:
u_{i,j}=y_{i,index(T,j)}; j=1, . . . , N(T) (29)

The step of extracting the actual codevector 302 includes determining the appropriate codevector element y_{i,j} to extract for each actual codevector element u_{i,j}. Step 302 is shown in more detail in FIG. 4 and includes, defining a codevector index 320 and determining the actual codevectors 322. Defining a codevector index 320 includes defining an index relationship and determining a value for the codevector index index(T,j) according to the index relationship. Generally, the index relationship defines the codevector index index(T,j) as a function of the pitch period T and according to the following equation:

$$index ( T , j ) = round ( \frac{( {N}_{v} - 1 ) {ω}_{j}}{π} ) = round ( \frac{2 ( {N}_{v} - 1 ) j}{T} ) ; \\ j = 1 , … N ( T ) \qquad ( 30 )$$

where round(x) converts x to the nearest integer either by rounding up or rounding down and if x is a non-integer multiple of 0.5, round (x) may be defined to either round up or round down. FIG. 5 shows an example of the inverse dependence of index(T,j) defined by the index relationship with the pitch period T as indicated by equation (30). As the pitch period increases, the vertical separation between the dots in the graph gets smaller. Once the codevector index index(T,j) has been defined, the actual codevectors are determined in step 322 according to equations (25) and (29).

Returning to FIG. 3, once the actual codevectors are extracted from each codevector in a codebook, the distortion measure between the harmonic magnitude vector and each actual codevector is computed 304. The distortion measure is the distortion measure defined by the partition rule chosen during codebook generation. Generally, the distortion measure is a distance measure, which is defined as a distance between the actual codevector uᵢ as defined in equation (26) and the harmonic magnitude being quantized x, as expressed according to the following equation:
d(x,uᵢ)=d(x, C(T)yᵢ); i=0 to N_{c}−1 (31)

The step of choosing the codevector corresponding to the optimum actual codevector 306 includes designating the actual codevector with which the distortion measure is the lowest as the “optimum actual codevector” and choosing the codevector corresponding to the optimum actual codevector (or its codevector index) to represent the harmonic magnitude vector 306.

As was necessary in the vector quantization techniques, before any harmonic magnitudes can be quantized, a codebook must be generated. However, some mathematical difficulties can arise in connection with generating the codebook with the GLA if certain distance measures are used. When using GLA, it is possible to choose a distance measure that results in the need to invert a singular matrix during the centroid computation step, thus making the optimum codevectors extremely difficult to calculate.

An example of a distance measure that leads to the need to invert a singular matrix is the distance measure that is defined below in equation (32). This distance measure is commonly used because it is very simple and produces good results at a low computational cost. This distance measure is defined according to:
d(xₖ, C(Tₖ)yᵢ)=∥xₖ−C(Tₖ)yᵢ+gₖ 1̅∥² (32)
where the harmonic magnitude vector xₖ and the codevector yⱼ are in the log domain; 1̅ is a vector whose elements are all ones with dimension N(T) (the “all-one vector”); and gₖ is the optimal gain, where the optimal gain is the gain which satisfies the following equation:

$${g}_{k} = \frac{1}{N ( {T}_{k} )} ( {y}_{i}^{T} {C ( {T}_{k} )}^{T} \overline{1} - {\overline{1}}^{T} {x}_{k} ) \qquad ( 33 )$$

and can also be expressed in terms of the difference between the mean of the actual codevector μ_{c(T}_{ₖ}₎_{_{yi}} and the mean of the harmonic magnitude vector μₓₖ according to the following equation:
gₖ=μ_{c(Tk)yi}−μₓₖ (34)

Substituting equation (34) into equation (32) yields the following equation:
d(xₖ, C(Tₖ)yᵢ)=∥(xₖ−μₓ_{ₖ}1)−(C(Tₖ)yᵢ−μ_{C(T}_{ₖ})y_{ᵢ}1)∥² (35)

As indicated by equation (35), the distance measure given in equation (32) leads to a mean-removed VQ equation (equation (35)) in which the means of both the harmonic magnitude vector and the codevector are subtracted out. To compute the centroid, the codevector yᵢ that minimizes equation (35), the optimum codevector, needs to be determined. Solving for yᵢ leads to the following equation:

$${\sum }_{k , {i}_{k} = i} Ψ ( {T}_{k} ) {y}_{i} = {\sum }_{k , {i}_{k} = i} {C ( {T}_{k} )}^{T} {x}_{k} + {g}_{k} {C ( {T}_{k} )}^{T} \overline{1} \qquad ( 36 )$$

where Ψ(Tₖ) is defined according to the following equation:
Ψ(Tₖ)=C(Tₖ)^{T}C(Tₖ) (37)

Equation (36) can be represented in a simplified form by the following equation:
Φᵢyᵢ=vᵢ (38)
where Φᵢ is the centroid matrix and is defined according to the following equation:

$${Φ}_{i} = {\sum }_{k , {i}_{k} = i} Ψ ( {T}_{k} ) \qquad ( 39 )$$

and vᵢ is defined according to the following equation:

$${v}_{i} = {\sum }_{k , {i}_{k} = i} {C ( {T}_{k} )}^{T} {x}_{k} + {g}_{k} {C ( {T}_{k} )}^{T} \overline{1} \qquad ( 40 )$$

Therefore, the optimum codevector is calculated as a function of the inverse of the centroid matrix Φ⁻¹ according to the following equation:
yᵢ=Φᵢ⁻¹vᵢ (41)

Because Φᵢ is a diagonal matrix, its inverse Φᵢ⁻¹ is relatively easy to find. However, elements of the main diagonal of Φᵢ might contain zeros, in which case, alternative methods must be used to solve for the optimum codevector.

Although VDVQ procedures offer an improvement over the previously mentioned methods with regard to the accuracy with which the harmonic magnitudes are encoded, in addition to the difficulties encountered when using certain distance measures to optimize the codebook, the rounding function included in the determination of the index relationship introduces errors that ultimately degrade the quality of the synthesized speech.

### BRIEF SUMMARY

Improved variable dimension vector quantization-related (“VDVQ-related”) processes have been developed that not only provide improvements in quality over existing VDVQ processes but can be applied to a wider variety of circumstances. More specifically, the improved VDVQ-related processes provide quality improvements in codebook generation and the quantization of harmonic magnitudes, and facilitate codebook generation or optimization for a broad range of distortion measures, including those that would involve inverting a singular matrix using known centroid computation techniques.

The improved VDVQ-related processes include, improved methods for extracting an actual codevector from a codevector, improved methods for codebook optimization, improved VDVQ procedures, improved methods for creating an optimum partition, and improved methods for harmonic coding. Additionally, these improved VDVQ-related processes can be implemented in software and various devices, either alone or in any combination. The various improved VDVQ-related devices include variable dimension vector quantization devices, optimum partition creation devices, and codebook optimization devices. The improved VDVQ-related processes can be further implemented into an improved harmonic coder that encodes the original speech signal for transmission or storage.

The improved VDVQ-related processes are based on improvements in the way in which actual codevectors are extracted from the codevectors in a codebook and improvements in the way in which codebooks are generated and optimized. In general, the methods for optimizing codebooks include determining the optimum codevectors using the principles of gradient-descent. By using the principles of gradient-descent, the problems associated with inverting singular centroid matrices are avoided, therefore, allowing the codevectors to be optimized for a greater collection of distance measures. In contrast, the improved methods for extracting an actual codevector from a codevector, in general, redefine the index relationship and use interpolation to determine the actual codevector elements when the index relationship produces a non-integer value. By using interpolation to determine the actual codevector elements, greater accuracy is achieved in coding and decoding the harmonic magnitudes of an excitation because the accuracy of the partitions used in creating the codebook is increased, as well as the accuracy with which the harmonic magnitudes are quantized.

In order to test the performance of the improved VDVQ related processes, improved VDVQ quantizers having a variety of dimensions and resolutions were created, tested and the results of the testing were compared with those resulting from similar testing of quantizers implementing various known harmonic magnitude modeling and/or quantization techniques. Experimental results comparing the performance of these improved VDVQ quantizers to the performance of the various known quantizers demonstrated that the improved VDVQ quantizers produce the lowest average spectral distortion under the tested conditions. In fact, the improved VDVQ quantizers demonstrated a lower average spectral distortion than quantizers implementing a known constant magnitude approximation without quantization and quantizers implementing a known partial harmonic magnitude technique without quantization. Additionally, the improved VDVQ quantizers outperformed quantizers based on the known HVXC coding standard implementing a known variable to fixed conversion technique, as well as quantizers obeying the basic principles of a known VDVQ procedure, where the improved VDVQ quantizers had a comparable complexity, or only a moderate increase in computation, respectively.

### BRIEF DESCRIPTION OF THE DRAWINGS

This disclosure may be better understood with reference to the following figures and detailed description. The components in the figures are not necessarily to scale, emphasis being placed upon illustrating the relevant principles. Moreover, like reference numerals in the figures designate corresponding parts throughout the different views.

FIG. 1 is flow chart of a harmonic analysis process, according to the prior art;

FIG. 2 is a flow chart of a generalized Lloyd algorithm for optimizing a codebook, according to the prior art;

FIG. 3 is a flow chart of a variable dimension vector quantization procedure, according to the prior art;

FIG. 4 is a flow chart of a method for extracting an actual codevector from a codevector in a codebook, according to the prior art;

FIG. 5 is a graph of codevector indices as a function of pitch period, according to the prior art;

FIG. 6 is a flow chart of an embodiment of an improved method for extracting an actual codevector from a codevector in a codebook;

FIG. 7 is a flow chart of an embodiment of a method for creating an optimum partitioning for a codebook;

FIG. 8 is a flow chart of an embodiment of an improved variable dimension vector quantization procedure;

FIG. 9 is a flow chart of an embodiment of an improved method for codebook optimization;

FIG. 10 is a flow chart of an embodiment of a method for updating current optimum codevectors using gradient-descent;

FIG. 11 is a flow chart of an embodiment of an improved method for harmonic coding; (In Box 910: VDVQ for the present case is only applied to the harmonic magnitudes, the other parameters use other (undefined) quantization methods).

FIG. 12A is a graph of the spectral distortion resulting from the training data set quantized using an improved VDVQ quantizer as a function of quantizer resolution and according to codevector dimension;

FIG. 12B is a graph of the spectral distortion resulting from the testing data set quantized using an improved VDVQ quantizer as a function of quantizer resolution and according to codevector dimension;

FIG. 13A is a graph of the spectral distortion resulting from the training data set quantized using an improved VDVQ quantizer as a function of codevector dimension and according to quantizer dimension;

FIG. 13B is a graph of the spectral distortion resulting from the testing data set quantized using an improved VDVQ quantizer as a function of codevector dimension and according to quantizer dimension;

FIG. 14A is a graph of the difference in spectral distortion (ASD) resulting from the training data set quantized using an improved VDVQ quantizer and the training data set quantized using a known VDVQ quantizer as a function of quantizer resolution and according to codevector dimension;

FIG. 14B is a graph of the difference in spectral distortion (ΔSD) resulting from the testing data set quantized using an improved VDVQ quantizer and the training data set quantized using a known VDVQ quantizer as a function of quantizer resolution and according to codevector dimension;

FIG. 15A is a graph of the spectral distortion resulting from the training data set quantized using an improved VDVQ quantizer and modeled and/or quantized using various other models and quantizers as a function of quantizer resolution and according to codevector dimension;

FIG. 15B is a graph of the spectral distortion resulting from the testing data set quantized using an improved VDVQ quantizer and modeled and/or quantized using various other models and quantizers as a function of quantizer resolution and according to codevector dimension;

FIG. 16 is a block diagram of an improved VDVQ device; and

FIG. 17 is a block diagram of an optimized harmonic coder.

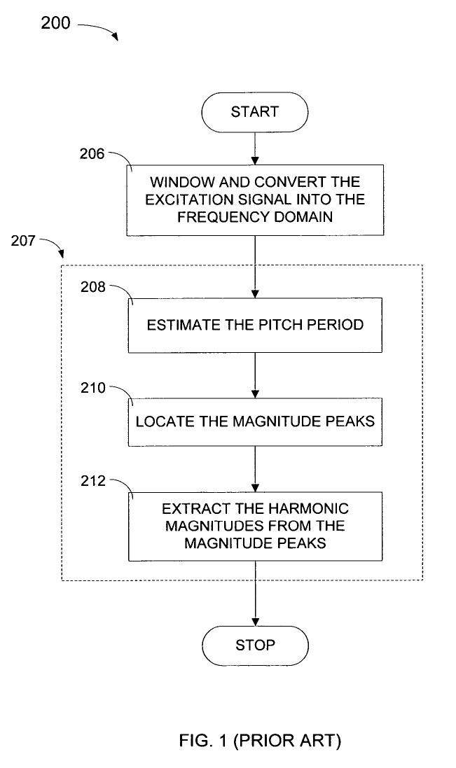

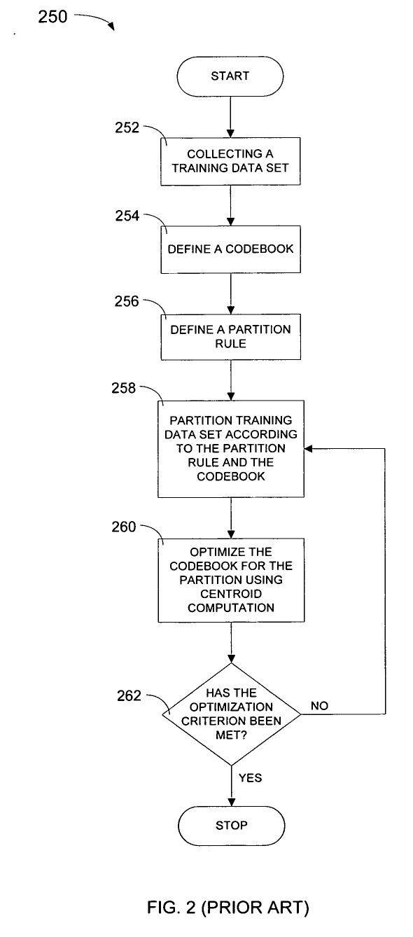

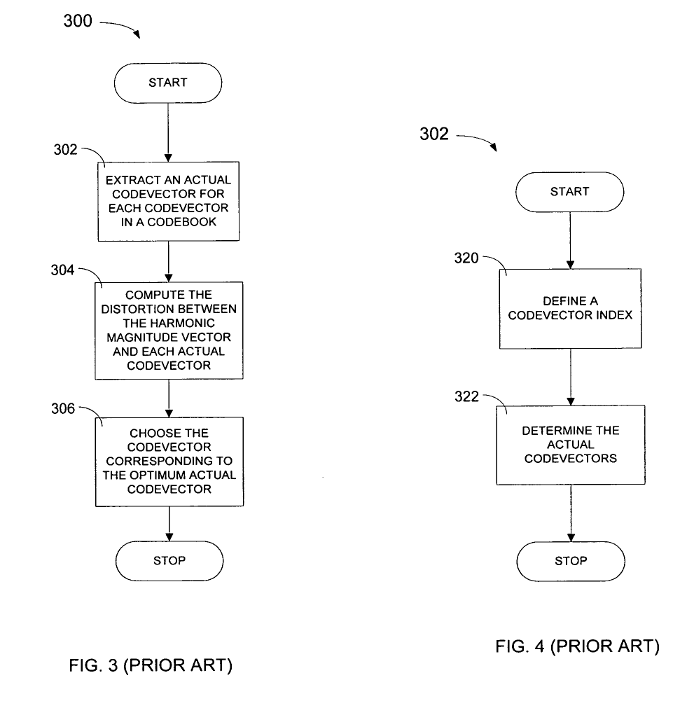

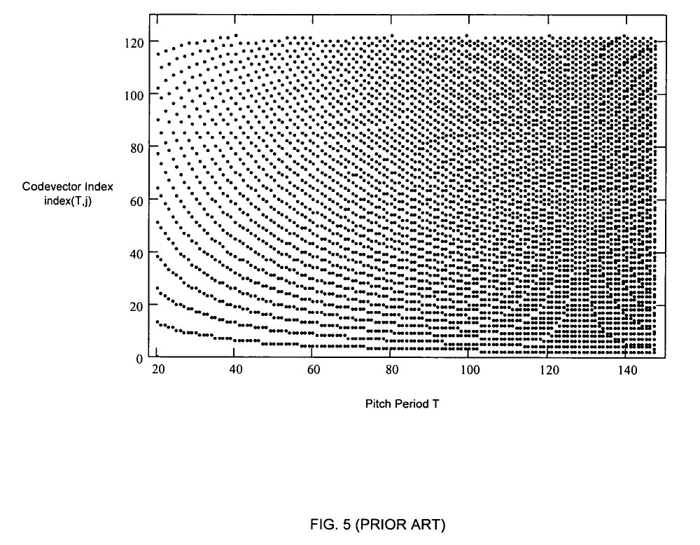

### DETAILED DESCRIPTION

Improved variable dimension vector quantization-related (“VDVQ-related”) processes have been developed that not only provide improvements in quality over existing VDVQ processes but can be applied to a wider variety of circumstances. More specifically, the improved VDVQ-related processes provide quality improvements in codebook generation and the quantization of harmonic magnitudes, and facilitate codebook generation or optimization for a broad range of distortion measures, including those that would involve inverting a singular matrix using known centroid computation techniques.

The improved VDVQ-related processes include, improved methods for extracting an actual codevector from a codevector, improved methods for codebook optimization, improved VDVQ procedures, improved methods for creating an optimum partition, and improved methods for harmonic coding. Additionally, these improved VDVQ-related processes have been implemented in software and various devices to create improved VDVQ-related devices that include actual codevector extraction devices, improved VDVQ devices, and codebook optimization devices.

The improved VDVQ-related processes are based on improvements in the way in which actual codevectors are extracted from the codevectors in a codebook and improvements in the way in which codebooks are generated and optimized. In general, the methods for optimizing codebooks include determining the optimum codevectors using the principles of gradient-descent. By using the principles of gradient-descent, the problems associated with inverting singular centroid matrices are avoided, therefore, allowing the codevectors to be optimized for a greater collection of distance measures. In contrast, the improved methods for extracting an actual codevector from a codevector, in general, redefine the index relationship and use interpolation to determine the actual codevector elements when the index relationship produces a non-integer value. By using interpolation to determine the actual codevector elements, greater accuracy is achieved in coding and decoding the harmonic magnitudes of an excitation because the accuracy of the partitions used in creating the codebook is increased, as well as the accuracy with which the harmonic magnitudes are quantized.

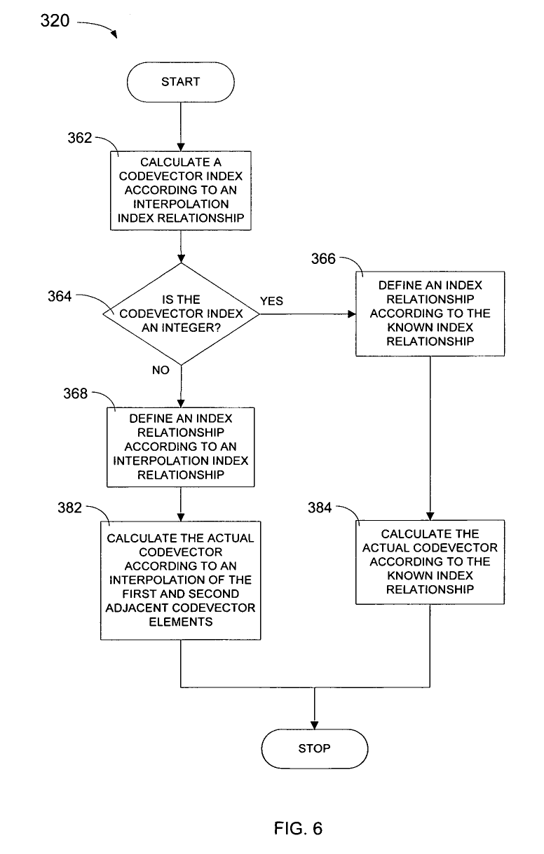

An improved method for extracting an actual codevector from a codevector in a codebook is shown in FIG. 6. This method 320 generally includes: calculating a codevector index according to an interpolation index relationship 362; determining whether the codevector index is an integer 364; where if the codevector index is an integer, defining the index relationship according to the known index relationship 366; and calculating the actual codevector according to the known index relationship 384; where if the codevector index is not an integer, defining the index relationship according to an interpolation index relationship 368 and calculating the actual codevector by interpolating the corresponding codevector elements.

Calculating a codevector index according to an interpolation index relationship 362 includes determining a value for index(T,j) as a function of the pitch period T and the codevector dimension Nᵥ according to the following equation:

$$index ( T , j ) = \frac{2 ( {N}_{v} - 1 ) j}{T} ; j = 1 , … , N \qquad ( 42 )$$

The interpolation index relationship of equation (42) differs from the known index relationship of equation (30) in that the interpolation index relationship does not define the values for the codevector index index(T,j) by rounding off.

It is then determined in step 364 whether the codevector index as determined by equation (42) is an integer. This determination may be made by determining whether the following equation is satisfied:
┌index (T,j)┐=└index (T,j)┘ (43)
where ┌x┐ is a ceiling function that returns the smallest integer that is larger than x; └x┘ is a floor function that returns the largest integer that is smaller than x. ┌index(T,j)┐ is a first rounded index and is equal to the value obtained in equation (42) rounded up to the next highest integer; and └index(T,j)┘ is a second rounded index and is equal to the value obtained in equation (42) rounded down to the next lowest integer. If the first rounded index equals the second rounded index, the codevector index as defined by equation (42) must be an integer.

If it is determined in step 364 that the codevector index as determined by the interpolation codevector relationship is an integer, the index relationship is defined according to a known index relationship 366, such as is given in equation (30) and the actual codevector uᵢ is calculated by determining each codevector element uᵢⱼ according to equation (29) where the codevector index index(T,j) is determined according to the known index relationship of equation (30) in step 384.

However, if it is determined in step 364 that the codevector index is not an integer, the index relationship index(T,j) is defined according to the interpolation index relationship of equation (42) 368. The actual codevector uᵢ is then determined in step 382 by determining the actual codevector elements u_{i,j} according to an interpolation of codevector elements. The interpolation may involve any number of codevector elements, each of which is weighted using a weighting function. For example, if the interpolation is between two codevector elements, the interpolation is an interpolation of a first adjacent codevector element y_{i,┌index(T,j)┐} and a second adjacent codevector element y_{i,└index(T,j)┘} according to the following equation.
u_{i,j}=(index (T,j)−└index (T,j)┘)y_{i,┌index(T,j)┐}+(┌index (T,j)┌−index (T,j))y_{i,└index(T,j)┘} (44)
wherein the weighting function assigned to the first adjacent codevector element is index(T,j)−└index(T,j)┘ and the weighting function assigned to the second adjacent codevector element is ┌index(T,j)┐−index(T,j).

Alternatively, the actual codevector uᵢ can be determined in step 382 as a function of a selection matrix C(T) according to equation (26). The selection matrix C(T) is essentially a matrix of all the weighting functions and is defined according to equation (27). The selection matrix elements c^{T}_{j,m} are determined according to the following equations:
c^{T}_{j,m}=index (T,j)└index (T,j)┘; if ┌index (T,j)┐=m (45a)
c^{T}_{j,m}=0; otherwise (45b)

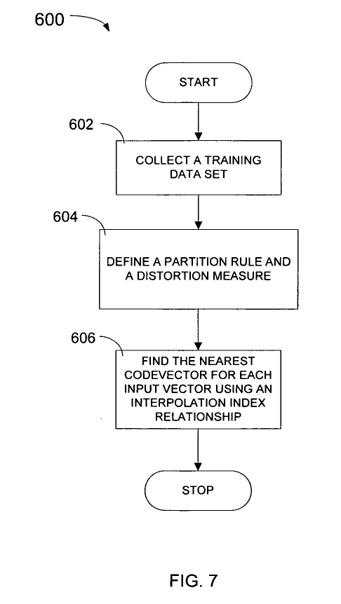

The improved methods for extracting an actual codevector from a codevector, such as the one shown in FIG. 6, can also be implemented in a method for creating an optimum partition. The method for creating an optimum partition uses an interpolation index relationship to produce the optimum partition for a given codebook. An example of a method for creating an optimized partition 600 is shown in FIG. 7 and includes: defining a codebook 601; collecting a training data set 602; defining a distortion measure 604; and determining the optimum partition by extracting an actual codevector from each codevector in the codebook using an interpolation index relationship 606.

Defining a codebook 601 generally includes, defining a number of codevectors to use as a starting point according to a known method, such as a partition creation and optimization method using a nearest-neighbor search. Collecting a training data set includes defining a set of Nₜ training vectors that will represent all possible harmonic magnitudes 602 includes defining a number of training vectors xₖ associated with a pitch period Tₖ for k=0 to Nₜ−1, and denoted according to equation (22), where Nₜ is the size of the training data set. Defining a distortion measure 604 generally includes defining the distortion measure using some distance measure of the distance between a training vector xₖ and a codevector yⱼ. One example of such a distance measure is the distance measure defined in equation (32). Therefore, the next step, determining the optimum partition by extracting an actual codevector from each codevector in the codebook using an interpolation index relationship 606, includes determining the optimum partition using an improved method for extracting an actual codevector to create an actual codevector for each codevector in the codebook and associating each training vector with the codevector corresponding to the actual codevector with which that training vector minimizes the distance measure. The actual codevector with which a training vector minimizes the distance measurement can be found by satisfying equation (23) according to a known method such as the nearest-neighbor search.

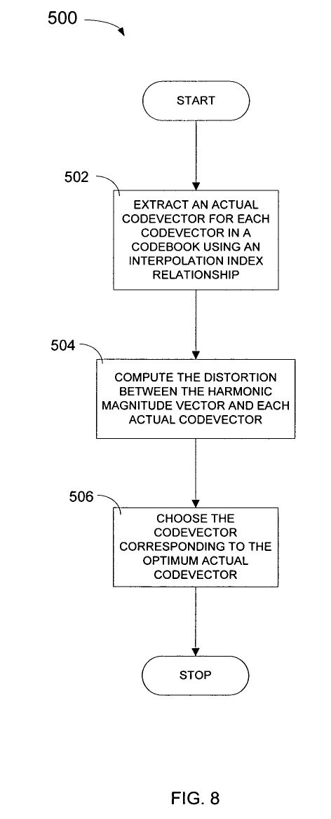

The improved method for extracting an actual codevector from a codevector, such as the one shown in FIG. 6, can be implemented in an improved VDVQ procedure. The improved VDVQ procedure maps harmonic magnitude vector having a variable input vector dimension N(Tₖ) to the appropriate codevector yᵢ in a codebook, where the codevector has a codevector dimension Nᵥ and N(Tₖ) does not necessarily equal Nᵥ. An example of an improved VDVQ procedure 500 is shown in FIG. 8 and includes: extracting an actual codevector from each codevector in a codebook using an interpolation index relationship 502; computing the distortion measure between the harmonic magnitude and each actual codevector 504; and choosing the codevector corresponding to the optimum actual codevector 506. Extracting an actual codevector from each codevector in a codebook using an interpolation index relationship 502, generally includes performing an improved method for extracting an actual codevector from a codevector, such as the one shown in FIG. 6 and described herein. Step 502 in FIG. 8, therefore produces, for each codevector in a codebook, an actual codevector. This actual codevector is a function of a known index relationship when the index, as determined by an interpolation index relationship, is an integer, and is a function of the interpolation index relationship when the index is not an integer.

Once an actual codevector is extracted for each codevector, the distortion measure between the harmonic magnitude vector and each actual codevector is computed 504. The distortion measure is defined as the same distortion measure used to determine the optimum codevectors when the codebook was generated and optimized. Although it can be defined by any distortion measure, the distortion measure can be defined as a distance measure according to equation (31), which is the distance between the actual codevector uᵢ, as determined in step 502, and the harmonic magnitude. The step of choosing the codevector corresponding to the optimum actual codevector 506 includes designating the actual codevector with which the harmonic magnitude produced the lowest distortion as the “optimum actual codevector” and choosing the codevector corresponding to the optimum actual codevector to represent the harmonic magnitude vector 506. Alternately, the codevector index of the codevector corresponding to the optimum actual codevector may be chosen to represent the harmonic magnitude.

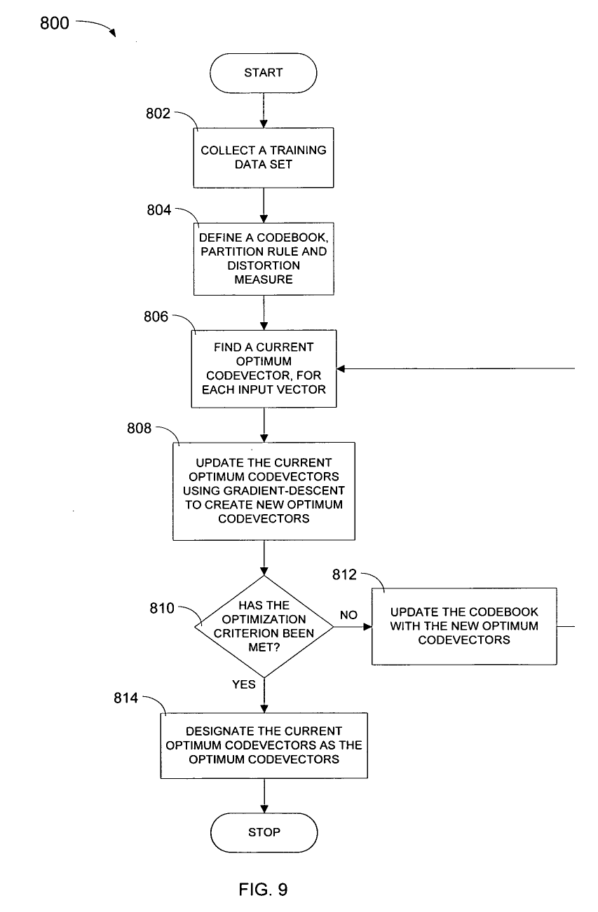

The improved method for extracting an actual codevector from a codevector can also be implemented in an improved method for codebook optimization as shown in FIG. 9. This method 800 uses the principle of gradient-descent instead of centroid computation to determine the optimum codevectors and thus avoids the problem of having to invert a singular centroid matrix. Gradient-descent is an iterative method for finding the minimum of function in terms of a variable by determining the partial derivative of the function with respect to the variable, adjusting the variable in a direction negative to the gradient to update the function, and redetermining the partial derivative of the updated function until the partial derivative of the function equals or is acceptably close to zero. The value for the variable that produces the function for which the partial derivative is zero or approaches zero is the value that minimizes the function.

The improved method for codebook optimization 800 generally includes: collecting a training data set 802; defining a codebook, partition rule and distortion measure 804; finding a current optimum codevector for each input vector 806; updating the current optimum codevectors using gradient-descent to create new optimum codevectors 808; determining whether the optimization criterion has been met 810; wherein if the optimization criterion has not been met, updating the codebook with the new optimum codevectors and repeating steps 806, 808, 810 and 812 until it is determined in step 810 that the optimization criterion has been met; wherein if the optimization criterion has been met, designating the current optimum codevectors as the optimum codevectors.

Collecting a training data set 802 generally consists of gathering a number of vectors from the signal source of interest that, in the present case, are a number of harmonic magnitude vectors from some speech signals. Defining a codebook in step 804 generally includes defining a number of codevectors according to any known method. Defining a partition rule in step 804 involves determining the rules by which the harmonic magnitude vectors are to be mapped to the codevectors. This generally includes defining the nearest-neighbor condition as the partition rule. Defining a distortion measure in step 804 includes defining a distance measure, such as the distance measure specified in equation (31).

Once the codevectors, partition rule and distortion measure are defined, they are used to find a current optimum codevector for each input vector 806. Finding a current optimum codevector for each input vector 806 involves finding the nearest codevector for each input vector using an interpolation index relationship by performing the improved VDVQ procedure for each input vector. Performing the improved VDVQ procedure for each input vector includes: extracting an actual codevector from each codevector using an interpolation index relationship; computing the distortion between the harmonic magnitude vector and each actual codevector; and choosing the codevector corresponding to the optimum actual codevector.

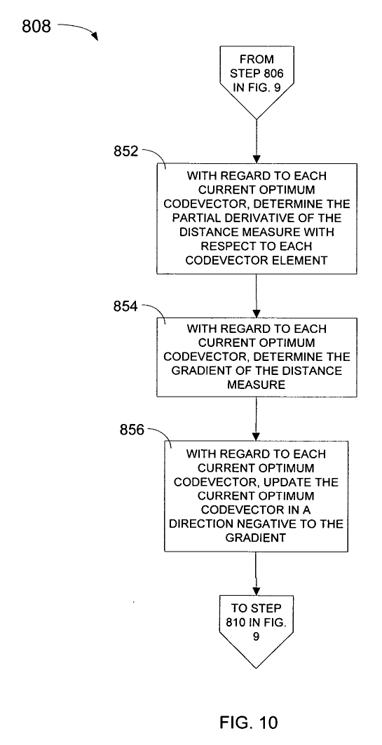

Once a current optimum codevector is determined for each input vector, these current optimum codevectors are updated using gradient-descent to create new optimum codevectors in step 808. Updating the current optimum codevectors 808 is shown in more detail in FIG. 10 and generally includes with regard to each of the current optimum codevectors: determining the partial derivative of the distance measure with respect to each codevector element 852; determining the gradient of the distance measure 854; and updating the codevector closest to the corresponding input vector in a direction negative to the gradient 856. Determining the partial derivative of the distance measure with respect to each codevector element 852 includes calculating the partial derivative of the distance measure in terms of each codevector element. If the distance measure is defined according to equation (32) the partial derivative of the distance measure with respect to each codevector element

$$\frac{\partial }{\partial {y}_{i , m}} = d ( {x}_{k} , C ( {T}_{k} ) {y}_{i} )$$

is determined according to the following equation:

$$\frac{\partial }{\partial {y}_{i , m}} d ( {x}_{k} , C ( {T}_{k} ) {y}_{i} ) = {\sum }_{j = 1}^{N ( {T}_{k} )} 2 ( {u}_{i , j} - {x}_{k , j} - {g}_{k} ) \frac{\partial {u}_{i , j}}{\partial {y}_{i , m}} \qquad ( 46 )$$

where

$$\frac{\partial {u}_{i , j}}{\partial {y}_{i , m}}$$

is the partial derivative of an actual codevector element u_{i,j} with respect to a codevector element y_{i,m}, where u_{i,j} is determined according to equation (29) if equation (43) is satisfied and according to equation (44) otherwise. Therefore,

$$\frac{\partial {u}_{i , j}}{\partial {y}_{i , m}}$$

can be determined according to the following equations:

$$\begin{matrix}\frac{\partial {u}_{i , j}}{\partial {y}_{i , m}} = 1 ; if ⌈ index ( T , j ) ⌉ = ⌊ index ( T , j ) ⌋ and m = index ( T , j ) & ( 47 a ) \\ \frac{\partial {u}_{i , j}}{\partial {y}_{i , m}} = index ( T , j ) - ⌊ index ( T , j ) ⌋ ; \\ if ⌈ index ( T , j ) ⌉ \neq ⌊ index ( T , j ) ⌋ and m = ⌈ index ( T , j ) ⌉ & ( 47 b ) \\ \frac{\partial {u}_{i , j}}{\partial {y}_{i , m}} = ⌈ index ( T , j ) ⌉ - index ( T , j ) ; \\ if ⌈ index ( T , j ) ⌉ \neq ⌊ index ( T , j ) ⌋ and m = ⌊ index ( T , j ) ⌋ & ( 47 c ) \\ \frac{\partial {u}_{i , j}}{\partial {y}_{i , m}} = 0 ; otherwise & ( 47 d )\end{matrix}$$

Determining the gradient of the distance measure 854 includes determining the gradient of the distance measure according to the following equation:

$$∇ d ( {x}_{k} , C ( {T}_{k} ) {y}_{i} ) = ( \begin{matrix}\frac{\partial }{\partial {y}_{i , 1}} d ( {x}_{k} , C ( {T}_{k} ) {y}_{i} ) , \\ \frac{\partial }{\partial {y}_{i , 2}} d ( {x}_{k} , C ( {T}_{k} ) {y}_{i} ) , … , \frac{\partial }{\partial {y}_{i , N ( {T}_{k} )}} d ( {x}_{k} , C ( {T}_{k} ) {y}_{i} )\end{matrix} ) \qquad ( 48 )$$

Once the gradient of the distance measure ∇d(xₖ, C(Tₖ)yᵢ) has been determined, the current closest codevectors are updated in a direction negative to the gradient 856 according to the following equation:

$${y}_{i , m} ← {y}_{i , m} γ \frac{\partial }{\partial {y}_{i , m}} d ( {x}_{k} , C ( {T}_{k} ) {y}_{i} ) \qquad ( 49 )$$

where γ is a step size parameter, a value for which is generally determined prior to performing the method for determining the optimum codevectors 400 and is chosen based on considerations such as desired accuracy, update speed and stability. Additionally, the step size parameter γ can be chosen according to the following equation:

$$γ = \frac{2 {N}_{c}}{{N}_{t}} \qquad ( 50 )$$

where N_{c} is the number of codevectors and Nₜ is the number of training vectors.

Returning to FIG. 9, it is then determined whether an optimization criterion has been met 810. Determining whether an optimization criterion has been met 810 is performed pursuant to the nature of the optimization criterion used. The optimization criterion may include includes determining whether a specified number of iterations or epochs have been performed, a specified amount of time has passed, the SD has saturated or other optimization criterion has been met. Determining whether the SD has saturated includes determining the SD of the current optimum codevectors and the new optimum codevectors and determining whether the SD has decreased by less than a predetermined difference value from the current optimum codevectors to the new optimum codevectors. Additionally, the optimization criterion (or criteria) may include the gradient reaching or becoming less than a predetermined minimum value. Both the predetermined difference value and the predetermined minimum value are generally determined before the method for determining the optimum codevectors 400 is performed and represent a desired level of accuracy. The predefined difference value and the predefined minimum value are generally chosen in view of considerations such as desired computation speed, accuracy and computational load.

If it is determined in step 810 that the optimization criterion has not been met, the codebook is updated 812 by replacing the current optimum codevectors with the new current optimum codevectors so that the new current optimum codevectors become the current optimum codevectors. Thereafter, steps 806, 808, and 810 are reperformed and steps 812, 806, 808, and 810 are repeated until it is determined in step 810 that the optimization criterion has been met. When it is determined in step 810 that the optimization criterion has been met, the current optimum codevectors are designated as the optimum codevectors 814.

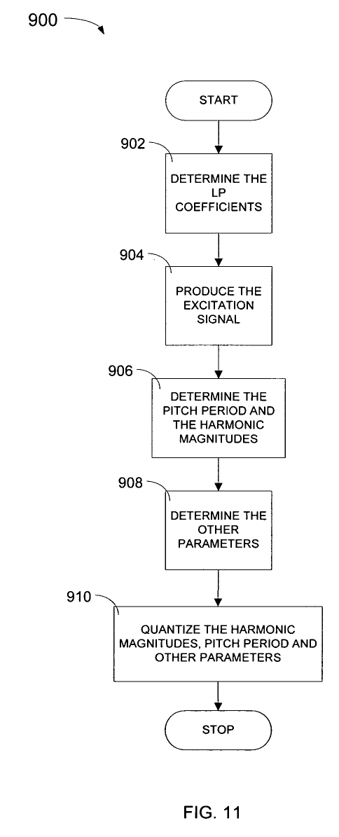

The improved VDVQ procedure, such as the one shown in FIG. 8, can be implemented in an improved method for harmonic coding. An example of an improved method for harmonic coding 900 is shown in FIG. 11 and includes: determining the LP coefficients 902; producing the excitation signal 904; determining the pitch period and the harmonic magnitudes 906; determining the other parameters 908; and quantizing the harmonic magnitudes, pitch period and other parameters 910.

Determining the LP coefficients 902 generally includes performing an LP analysis on each frame of a speech signal that is being coded. Producing the excitation signal 904 generally includes using the LP coefficients to define an analysis filter, which is the inverse of a synthesis filter, and filtering each frame of the speech signal with the inverse filter to produce an excitation signal in frames (each an “excitation signal frame”). Determining the pitch period and the harmonic magnitudes 906 is accomplished by performing harmonic analysis on each excitation signal frame to determine the harmonic magnitudes for that frame. Determining the other parameters 908 generally includes determining parameters such as gain, and those relating to power estimation, the voiced/unvoiced decision and filtering operations for each frame of the speech signal.

After the harmonic magnitudes, pitch period and other parameters are determined, they are quantized and encoded into a bit-stream in step 910. Quantizing the harmonic magnitudes, pitch period and other parameters 910 includes quantizing the pitch period and other parameters using known methods and quantizing the harmonic magnitudes using an improved variable dimension vector quantization procedure, such as is shown in FIG. 8. The improved variable dimension vector quantization procedure determines the index for the codevector in a codebook corresponding to the optimum actual codevector for each harmonic magnitude in an excitation frame. These indices, pitch period and other parameters are then encoded into a bit-stream for transmission or storage.

In order to test the performance of the improved VDVQ related processes, improved VDVQ quantizers having a variety of dimensions and resolutions were created, tested and the results of the testing were compared with those resulting from similar testing of quantizers implementing various known harmonic magnitude modeling and/or quantization techniques. Experimental results comparing the performance of these improved VDVQ quantizers to the performance of the various known quantizers demonstrated that the improved VDVQ quantizers produce the lowest average SD under the tested conditions. In fact, the improved VDVQ quantizers demonstrated a lower average SD than quantizers implementing a known constant magnitude approximation without quantization (the “known LPC models”) and quantizers implementing a known partial harmonic magnitude technique without quantization (the “known MELP models”). Additionally, the improved VDVQ quantizers outperformed quantizers based on the known HVXC coding standard implementing a known variable to fixed conversion technique (the “known HVXC quantizers”), as well as quantizers obeying the basic principles of a known VDVQ procedure (the “known VDVQ quantizers”). The improvement in quality was achieved at a complexity comparable to that of the known HXVC quantizers and with only a moderate increase in computation when compared to the known VDVQ quantizers.

The training data used to design the improved VDVQ quantizers and the known VDVQ quantizers; and the testing data used to test all the quantizers was obtained from the TIMIT database. The training data was obtained from 100 sentences chosen from the TIMIT database that were downsampled to 8 kHz. To obtain the training data, the 100 sentences were windowed to obtain frames of 160 samples/frame. The harmonic magnitudes of these sentences were obtained from the prediction error and had variable dimensions. The prediction error of each frame was determined using LP analysis and then mapped into the frequency domain by windowing the prediction error with a Hamming window and using a 256-sample FFT. An autocorrelation-based pitch period estimation algorithm was designed and used to determine the pitch period. The pitch period was determined to have a range of [20,147] at steps of 0.25; thus, allowing fractional values for the pitch periods. The harmonic magnitudes were then extracted only from the voiced frames which were determined according to the estimated pitch period. This process yielded approximately 20000 training vectors in total. To obtain the testing data set, a similar procedure was used to extract the testing data from 12 sentences, which yielded approximately 2500 vectors.

Thirty (30) improved VDVQ quantizers were created for comparison with the known quantizers. For each of these 30 improved VDVQ quantizers, a codebook including a plurality of codevectors and a partition was determined. These 30 improved VDVQ quantizers included five (5) groups of quantizers where each group of quantizers has a specific dimension Nᵥ and where within each group of quantizers, each improved quantizer has a different resolution. For the first group of improved VDVQ quantizers, the dimension is Nᵥ=41; for the second group of quantizers, the dimension is Nᵥ=51; for the third group of quantizers, the dimension is Nᵥ=76; for the third group of quantizers, the dimension is Nᵥ=101; and for the fifth group of quantizers, the dimension is Nᵥ=129. Each of these groups of quantizers included six improved quantizers, each with a different resolution. The first improved VDVQ quantizer in each group had a resolution r=5, the second had a resolution r=6; the third had a resolution r=7; the fourth had a resolution r=8, the fifth had a resolution r=9, and the sixth had a resolution r=10.

The codebooks for each of the 30 improved VDVQ quantizers were created using the training data and the improved method for codebook optimization as described herein in connection with FIG. 9, with the initial values for the codevectors being the codevectors for the corresponding known VDVQ coders (described subsequently). Therefore, the optimum partition for the codebook was determined using an interpolation index relationship and the optimum codevectors were determined using gradient-descent. The optimization criterion used to determine when to stop the training process was the saturation of the SD for the entire training data set. After each epoch (an epoch is defined as one complete pass of all the training data in the training data set through the training process), the average of the SD with regard to the training data was determined and compared with the average SD of the previous epoch. If the SD had not gotten smaller by at least a predefined amount, the average SD was determined to be in saturation and the training procedure was stopped. Furthermore, the step size parameter was chosen according to equation (50) and the distance measure used to create the partition (and later to quantize the test data) was the distance measure defined in equation (32).

Additionally, 30 known VDVQ quantizers were created for comparison with the improved VDVQ quantizers. These 30 known VDVQ quantizers have the same dimensions and resolutions as the improved VDVQ quantizers. The codevectors and partitions for each of the 30 known VDVQ quantizers were created using the training data and the GLA to optimize a randomly created initial codebook. For each known VDVQ quantizer, a total of 10 random initializations were performed where each random initialization was followed by 100 epochs of training (where one epoch consists of a nearest neighbor search followed by centroid computation and where after each epoch it was determined if the average SD of the entire training data set had saturated). The distance measure used to create the partition (and later to quantize the test data) was the distance measure defined in equation (32).

Further, six (6) known HVXC quantizers were created. All of the known HVXC quantizers were designed to have a codebook with a codevector dimension of 44, where each of the six known HVXC quantizers had a different resolution (5, 6, 7, 8, 9 and 10 bits, respectively). The codevectors and partitions for each of the known HVXC quantizers were created using the GLA where the GLA optimized initial codevector created by interpolating the training vectors to 44 elements. For each known HVXC quantizer, a total of 10 random initializations were performed where each random initialization was followed by 100 epochs of training. One epoch is a complete pass of all the data in the training data set. In actual training, each vector in the training data set is presented sequentially to the GLA, when all the vectors are passed and the codebook updated, one epoch has passed. The training process is then repeated with the next epoch, where the same training vectors are presented.

In the experiments, initially the performance of the 30 improved VDVQ quantizers in terms of SD was determined as a function of both dimension and resolution. The performance of these improved VDVQ quantizers was then compared to the performance of the corresponding VDVQ quantizers (the corresponding known VDVQ quantizer is the known VDVQ quantizer having the same resolution and dimension as the improved VDVQ quantizer to which it corresponds), also in terms of both dimension and resolution. Then, the performance as a function of resolution of the improved VDVQ quantizers with a codevector dimension of 41 was compared to the performance of a known LPC model, a known MELP model, the known HVXC quantizers, and the known VDVQ quantizers having a codebook dimension of 41.

The SD of the 30 improved VDVQ quantizers is shown in FIG. 12A, 12B, 13A and 13B. FIG. 12A shows the SD for all 30 improved VDVQ quantizers as a function of resolution for the training data, and FIG. 12B shows the SD for all 30 improved VDVQ quantizers as a function of resolution for the testing data. FIG. 13A shows the SD for all 30 improved VDVQ quantizers, grouped according to resolution, as a function of dimension for the training data and FIG. 13B shows the SD for all 30 improved VDVQ quantizers, grouped according to resolution, as a function of dimension for the testing data.

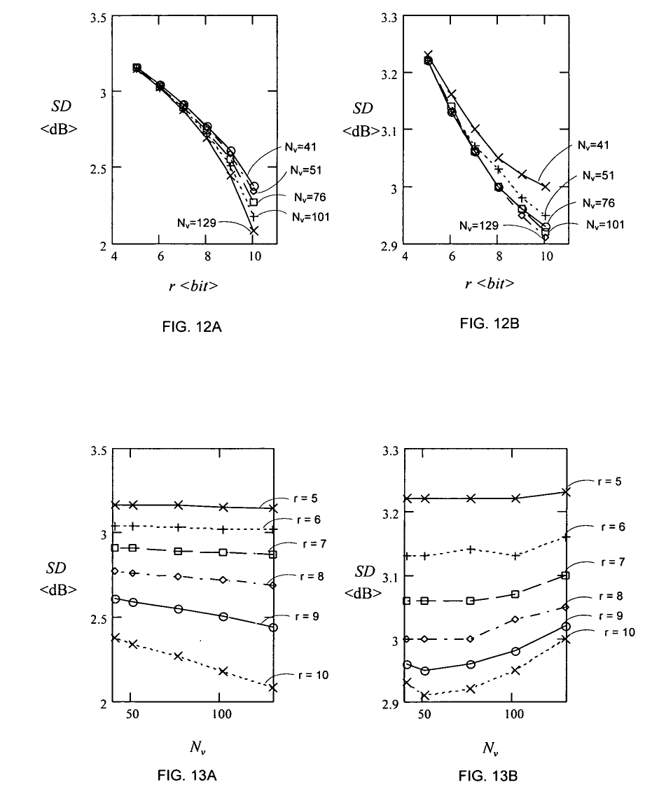

FIG. 14A, 14B, show the difference between SD resulting from the improved VDVQ quantizers and the SD resulting from the known VDVQ quantizers (“ΔSD ”). In FIG. 14A, the difference in SD ΔSD is shown for the training data and is grouped according to the dimension of the quantizers from which it was produced and presented as a function of resolution. In FIG. 14B, the difference in SD, ΔSD is shown for the testing data and is grouped according to the dimension of the coders from which it was produced and presented as a function of resolution. With regard to the training data, the introduction of interpolation among the elements of the codevectors through the use of the interpolation index relationship produces a reduction in the average SD. The amount of this reduction tends to be higher for the lower dimension coders with higher resolution. With regard to the testing data, the introduction of interpolation among the elements of the codevectors through the use of the interpolation index relationship generally produces a reduction in the average SD.

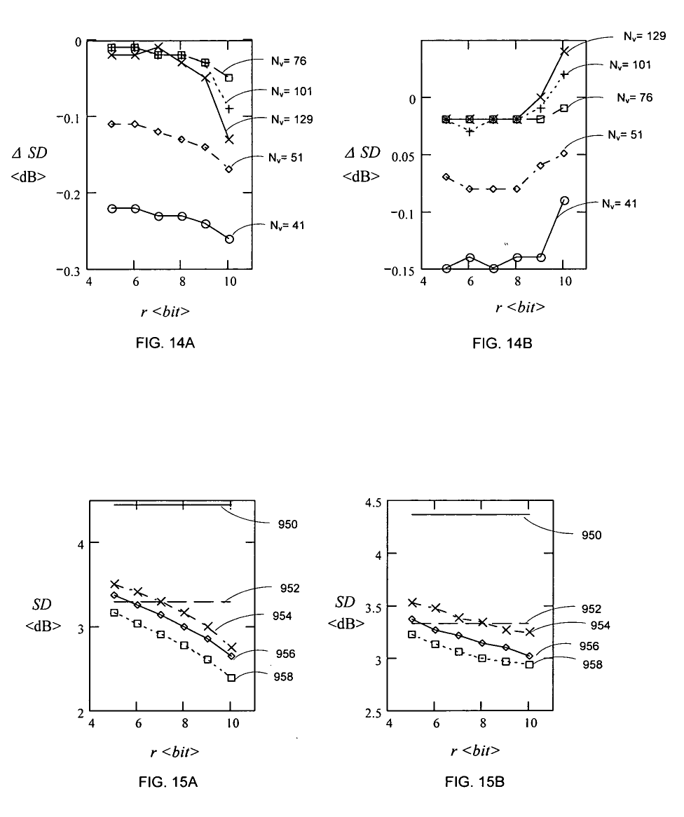

FIG. 15A and 15B show the SD as a function of resolution produced by the known LPC models 950, the known MELP models 952; the known HVXC quantizers 954, the known VDVQ quantizers with a codevector dimension of 41 956; and the improved VDVQ quantizers with a codevector dimension of 41 958. FIG. 15A shows the SD as a function of resolution for the training data and FIG. 15B shows the SD as a function of resolution for the testing data. The SD of the improved VDVQ quantizers is significantly lower that of the known HVXC and known VDVQ quantizers. This difference has particular significance with regard to the known HVXC quantizers because the known HVXC quantizers have a codebook resolution higher than that of the improved VDVQ quantizer.

Furthermore, the SD for the improved VDVQ quantizers was significantly lower than the SD of the known LPC model and the known MELP model, particularly at higher resolutions. Because both the known LPC model and the known MELP model did not include quantization, their respective resolutions were infinite and therefore, their respective SDs were constant (for the LPC model the SD was 4.44 dB for the training data and 4.36 dB for the testing data; and for the MELP model the SD was 3.29 dB for the training data and 3.33 dB for the testing data). The SD values shown in FIG. 19A and 19B for the known LPC model and the known MELP model reflect only the distortion inherent in the models and do not reflect any distortion due to quantization. Therefore, these SD values represent the best possible performance for these quantizers in that, if quantization were added, the SD would only degrade.

Implementations and embodiments of the improved VDVQ-related processes, including improved methods for extracting an actual codevector from a codevector, methods for creating an optimum partition for a codebook, improved variable dimension vector quantization procedures, improved methods for codebook optimization, methods for updating current optimum codevectors using gradient-descent and improved methods for harmonic coding all include computer readable software code. Such code may be stored on a processor, a memory device or on any other computer readable storage medium. Alternatively, the software code may be encoded in a computer readable electronic or optical signal. The code may be object code or any other code describing or controlling the functionality described herein. The computer readable storage medium may be a magnetic storage disk such as a floppy disk, an optical disk such as a CD-ROM, semiconductor memory or any other physical object storing program code or associated data.

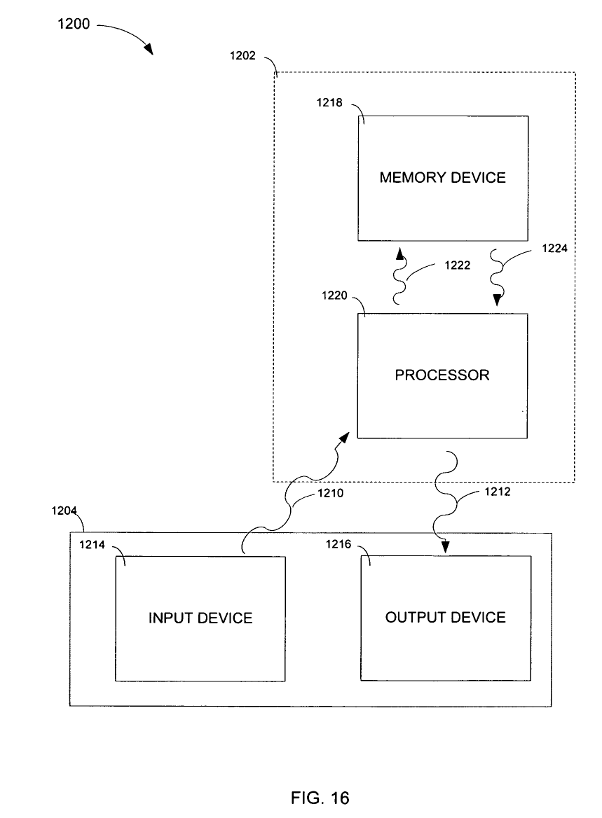

Additionally, improved VDVQ-related processes may be implemented in an improved VDVQ-related device 1200, as shown in FIG. 16, alone or in any combination. The improved VDVQ-related device 1200 generally includes an improved VDVQ-related unit 1202 and may also include an interface unit 1204. The improved VDVQ-related unit 1202 includes a processor 1220 coupled to a memory device 1216. The memory device 1218 may be any type of fixed or removable digital storage device and (if needed) a device for reading the digital storage device including, floppy disks and floppy drives, CD-ROM disks and drives, optical disks and drives, hard-drives, RAM, ROM and other such devices for storing digital information. The processor 520 may be any type of apparatus used to process digital information. The memory device 518 may store a speech signal, and any or all of the improved VDVQ-related processes, or any combination of the foregoing. Upon the relevant request from the processor 1220 via a processor signal 1222, the memory communicates the requested information via a memory signal 1224 to the processor 1220.

The interface unit 1204 generally includes an input device 1214 and an output device 1216. The output device 1216 receives information from the processor 1220 via a second processor signal 1212 and may be any type of visual, manual, audio, electronic or electromagnetic device capable of communicating information from a processor or memory to a person or other processor or memory. Examples of output devices include, but are not limited to, monitors, speakers, liquid crystal displays, networks, buses, and interfaces. The input device 1214 communicates information to the processor via an input signal 1210 and may be any type of visual, manual, mechanical, audio, electronic, or electromagnetic device capable of communicating information from a person or processor or memory to a processor or memory. Examples of input devices include keyboards, microphones, voice recognition systems, trackballs, mice, networks, buses, and interfaces. Alternatively, the input and output devices 1214 and 1216, respectively, may be included in a single device such as a touch screen, computer, processor or memory coupled to the processor via a network.

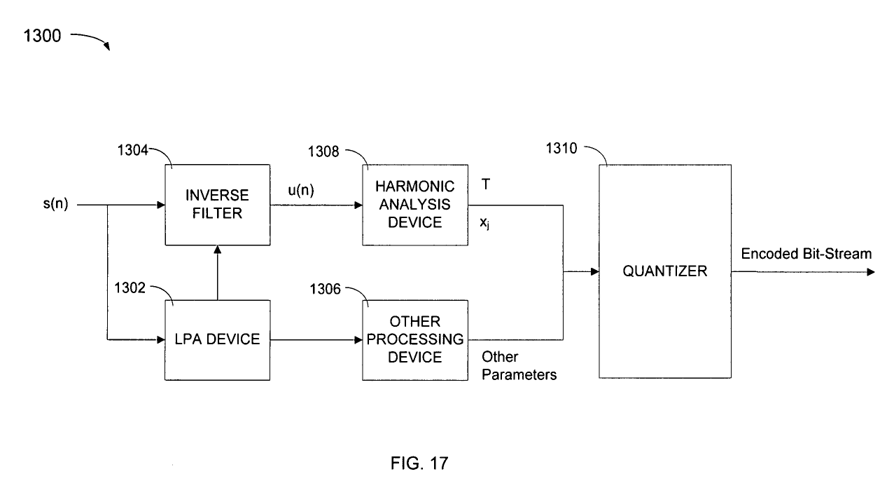

The improved VDVQ-related processes can be implemented into an improved harmonic coder that encodes the original speech signal for transmission or storage. An example of an improved harmonic coder 1300 is shown in FIG. 17. A harmonic coder 1300 generally includes an LPA device 1302; an inverse filter 1304; another process device 1306; a harmonic analysis device 1308; and a quantizer 1310. The LPA device 1302 performs LPA on the input signal s(n) to produce the LP coefficients. These LP coefficients are used to define an inverse filter 1304 that is simply the inverse of the synthesis filter. The inverse filter 1304 filters the input signal s(n) to produce the excitation signal u(n). The excitation signal u(n) is then analyzed by the harmonic analysis device 1308 using harmonic analysis to extract the fundamental frequency ω₀ and the harmonic magnitudes xⱼ.

The LP coefficients are also input into another process device 1306. The other process device 1306 uses the LP coefficients to determine other parameters such as, those relating to power estimation, the voiced/unvoiced decision and filtering options. The other parameters, the harmonic magnitudes xⱼ, and the pitch period T, are all input into the quantizer. The quantizer, using an improved method for codebook and partition optimization, uses the harmonic magnitudes xⱼ and the pitch period T to create the optimum codevectors and the optimum partitions to define a codebook. The quantizer then uses the codebook and an improved VDVQ procedure to quantize the harmonic magnitudes to produce quantized harmonic magnitudes yᵢ. Finally, the quantizer produces a bit-stream containing the quantized harmonic magnitudes yᵢ, the pitch period and the other parameters.

Although the methods and apparatuses disclosed herein have been described in terms of specific embodiments and applications, persons skilled in the art can, in light of this teaching, generate additional embodiments without exceeding the scope or departing from the spirit of the claimed invention. For example, the methods, devices and systems can be used in connection with image and audio coding.

What is claimed is:

1. A method for harmonic coding that produces an encoded bit-stream from an input signal, comprising:
determining at least one linear prediction coefficient for the input signal s[n] using linear prediction analysis;
producing an excitation signal u[n] using the at least one linear prediction coefficient and the input signal;
determining at least one pitch period Tₖ and at least one harmonic magnitude xₖ of the excitation signal u[n], wherein the at least one harmonic magnitude xₖ includes at least one harmonic magnitude element x_{k,j} and a variable harmonic magnitude dimension N(Tₖ);
determining other parameters using the linear prediction coefficients; and
quantizing the other parameters, the pitch period and the at least one harmonic magnitude xₖ to produce an encoded bit-stream, wherein the at least one harmonic magnitude is quantized using an improved variable dimension vector quantization procedure.

2. A computer readable storage medium storing computer readable program code for harmonic coding of an input signal, comprising:
data encoding a codebook, wherein the codebook includes at least one codevector yᵢ and wherein each of the at least one codevectors yᵢ includes a codevector magnitude Nᵥ and at least one codevector element y_{i,m}; and
a computer code implementing a method for harmonic coding in response to the input signal, wherein the method for harmonic coding includes:
determining at least one linear prediction coefficient for the input signal s[n] using linear prediction analysis;
producing an excitation signal u[n] using the at least one linear prediction coefficient and the input signal;
determining at least one pitch period Tₖ and at least one harmonic magnitude xₖ of the excitation signal u[n], wherein the at least one harmonic magnitude xₖ includes at least one harmonic magnitude element x_{k,j} and a variable harmonic magnitude dimension N(Tₖ);
determining other parameters using the linear prediction coefficients; and
quantizing the other parameters, the pitch period and the at least one harmonic magnitude xₖ to produce an encoded bit-stream, wherein the at least one harmonic magnitude is quantized using an improved variable dimension vector quantization procedure.

3. An optimized harmonic coder for encoding an input signal s[n] as an encoded bit-stream, comprising:
a linear prediction analysis device, wherein the linear prediction analysis device receives the input signal and produces a plurality of linear prediction coefficients;
an other processing device coupled to the linear prediction analysis device, wherein the other processing device produces at least one other parameter;
an inverse filter defined by the plurality of LP coefficients; wherein the inverse filter receives the input signal, is coupled to the linear prediction analysis device receiving the linear prediction coefficients therefrom, and produces an excitation signal;
a harmonic analysis device coupled to the inverse filter and receiving the excitation signal therefrom, wherein the harmonic analysis device produces a pitch period T and at least one harmonic magnitude xⱼ, wherein the harmonic magnitude includes a variable harmonic dimension N(Tₖ); and
a variable dimension vector quantizer coupled to the harmonic analysis device and the other processing device, wherein the variable dimension vector quantizer receives the pitch period T and the at least one harmonic magnitude xⱼ from the harmonic analysis device, and receives the other parameters from the other processing device; wherein the variable dimension vector includes a codebook which includes at least one codevector yᵢ and wherein the at least one codevector yᵢ includes a codevector dimension Nᵥ and at least one codebook element y_{i,m};
and wherein the variable dimension vector quantizer quantizes the pitch period, the at least one other parameter and the at least one harmonic magnitude xⱼ to produce the encoded bit-stream, wherein quantizing the at least one harmonic magnitude xⱼ, includes:
determining at least one linear prediction coefficient for the input signal s[n] using linear prediction analysis;
producing an excitation signal u[n] using the at least one linear prediction coefficient and the input signal;
determining at least one pitch period Tₖ and at least one harmonic magnitude xₖ of the excitation signal u[n], wherein the at least one harmonic magnitude xₖ includes at least one harmonic magnitude element x_{k,j} and a variable harmonic magnitude dimension N(Tₖ);
determining other parameters using the linear prediction coefficients; and
quantizing the other parameters, the pitch period and the at least one harmonic magnitude xₖ to produce an encoded bit-stream, wherein the at least one harmonic magnitude is quantized using an improved variable dimension vector quantization procedure.
